(19) United States
(12) Patent Application Publication
(10) Pub. No.: US 2024/0297372 A1
(43) Pub. Date: Sep. 5, 2024

(54) BATTERY CELL TAB THERMAL BARRIER INSERTION APPARATUS AND METHOD

(71) Applicant: Ford Global Technologies, LLC, Dearborn, MI (US)

(72) Inventors: Allen Joseph Gilbert, Grosse Ile, MI (US); Tyler William Roe, Brownstown, MI (US); Daryl Marlow, Dearborn, MI (US); Kimberley King, Northville, MI (US); Jason Luesing, Hazel Park, MI (US)

(21) Appl. No.: 18/115,941

(22) Filed: Mar. 1, 2023

(51) Int. Cl. H01M 10/658; H01M 10/613; H01M 10/625

(52) U.S. Cl. CPC H01M 10/658; H01M 10/613; H01M 10/625

(57) ABSTRACT

A method and apparatus comprise an insertion apparatus that has at least one loader. A preformed member comprised of a thermal barrier material is inserted into the at least one loader. The preformed member is pushed through the at least one loader and into an open area between adjacent battery cell tabs such that the preformed member expands to fill the open area.

### TECHNICAL FIELD

This disclosure relates generally to a method and apparatus for providing a preformed thermal barrier member between adjacent cell tabs of a traction battery pack.

### BACKGROUND

Electrified vehicles include a traction battery pack for powering electric machines and other electrical loads of the vehicle. The traction battery pack includes one or more battery arrays that each include a plurality of battery cells and various other battery internal components that support electric vehicle propulsion.

### SUMMARY

In some aspects, the techniques described herein relate to a method including: providing an insertion apparatus having at least one loader; inserting a preformed member comprised of a thermal barrier material into the at least one loader; pushing the preformed member through the at least one loader and into an open area between adjacent battery cell tabs such that the preformed member expands to fill the open area.

In some aspects, the techniques described herein relate to a method, wherein the thermal barrier material comprises a compressible foam material, and including compressing the preformed member during insertion through the at least one loader.

In some aspects, the techniques described herein relate to a method, wherein the at least one loader comprises a plurality of loaders, and including: providing a battery array comprised of a plurality of battery cells that each have battery cell tabs; aligning the plurality of loaders with respective open areas between adjacent battery cell tabs; and simultaneously pushing preformed members through the plurality of loaders and into the open areas such that all open areas are filled at the same time.

In some aspects, the techniques described herein relate to a method, wherein the insertion apparatus is comprised of a non-conductive material.

In some aspects, the techniques described herein relate to a method, wherein the at least one loader comprises a compression tube having an intake end and an exit end, and including forming the intake end to have a greater open cross-sectional area than an open cross-sectional area at the exit end such that as the preformed member is pushed through the compression tube, the preformed member is compressed from an initial outer dimension to a compressed outer dimension that is less than the initial outer dimension.

In some aspects, the techniques described herein relate to a method including using a plunger to push the preformed member through the compression tube.

In some aspects, the techniques described herein relate to a method including positioning the exit end of the compression tube between the adjacent battery cell tabs and pushing the preformed member toward the exit end and using the plunger to hold the preformed member between the adjacent battery cell tabs as the compression tube is withdrawn from the open area.

In some aspects, the techniques described herein relate to a method including providing a plurality of compression tubes each aligned with a respective open area between adjacent battery cell tabs of a battery array comprised of a plurality of battery cells, and simultaneously installing preformed members between all adjacent battery cell tabs of the battery array.

In some aspects, the techniques described herein relate to a method, wherein the at least one loader comprises a housing and a drum received within the housing, wherein the drum includes at least one internal cavity sized to receive one preformed member, and including an intake chute to be aligned with an intake end of the at least one internal cavity, and an exit chute to be aligned with an exit end of the at least one internal cavity, and including: rotating the drum within the housing such that the exit end is blocked and the intake end is aligned with the intake chute; loading the preformed member into the at least one internal cavity; rotating the drum within the housing such that the exit end is aligned with the exit chute and the intake chute is blocked; and pushing the preformed member through the exit chute and into the open area between the adjacent battery cell tabs.

In some aspects, the techniques described herein relate to a method, wherein the at least one internal cavity comprises a plurality of internal cavities formed within the drum, and including aligning each internal cavity with a respective open area between adjacent battery cell tabs of a battery array comprised of a plurality of battery cells such that the exit ends of the plurality of internal cavities are aligned with the respective exit chutes, and simultaneously installing preformed members between all adjacent battery cell tabs of the battery array by pushing the preformed members through the exit chutes.

In some aspects, the techniques described herein relate to an apparatus, including: a preformed member comprised of a thermal barrier material; an insertion structure having at least one loader configured to receive the preformed member; and a plunger that pushes the preformed member through the at least one loader and into an open area between adjacent battery cell tabs such that the preformed member expands to fill the open area.

In some aspects, the techniques described herein relate to an apparatus, wherein the preformed member is comprised of a compressible foam material that is compressed during insertion through the at least one loader.

In some aspects, the techniques described herein relate to an apparatus, wherein the at least one loader comprises a plurality of loaders, and including a battery array comprised of a plurality of battery cells that each have battery cell tabs, and wherein the plurality of loaders are aligned with respective open areas between adjacent battery cell tabs, and wherein preformed members are simultaneously pushed through the plurality of loaders and into the open areas such that all open areas are filled at the same time.

In some aspects, the techniques described herein relate to an apparatus, wherein the insertion structure is comprised of a non-conductive material.

In some aspects, the techniques described herein relate to an apparatus, wherein the at least one loader comprises a compression tube having an intake end and an exit end, and wherein the intake end has a greater open cross-sectional area than an open cross-sectional area at the exit end such that as the preformed member is pushed through the compression tube, the preformed member is compressed from an initial outer dimension to a compressed outer dimension that is less than the initial outer dimension.

In some aspects, the techniques described herein relate to an apparatus, wherein the plunger pushes the preformed member through the compression tube.

In some aspects, the techniques described herein relate to an apparatus, wherein the exit end of the compression tube is positioned between the adjacent battery cell tabs and the preformed member is pushed toward the exit end and the plunger holds the preformed member between the adjacent battery cell tabs as the compression tube is withdrawn from the open area.

In some aspects, the techniques described herein relate to an apparatus, wherein the compression tube comprises a plurality of compression tubes that are each aligned with a respective open area between adjacent battery cell tabs of a battery array comprised of a plurality of battery cells, and wherein preformed members are simultaneously installed between all adjacent battery cell tabs of the battery array.

In some aspects, the techniques described herein relate to an apparatus, wherein the at least one loader comprises a housing and a drum received within the housing, wherein the drum includes at least one internal cavity sized to receive one preformed member, and including an intake chute to be aligned with an intake end of the at least one internal cavity, and an exit chute to be aligned with an exit end of the at least one internal cavity, and wherein: the drum is first rotated within the housing such that the exit end is blocked and the intake end is aligned with the intake chute such that the preformed member is loaded into the at least one internal cavity; the drum is subsequently rotated within the housing such that the exit end is aligned with the exit chute and the intake chute is blocked; and the plunger pushes the preformed member through the exit chute and into the open area between the adjacent battery cell tabs.

In some aspects, the techniques described herein relate to an apparatus, wherein the at least one internal cavity comprises a plurality of internal cavities formed within the drum, where each internal cavity is aligned with a respective open area between adjacent battery cell tabs of a battery array comprised of a plurality of battery cells such that the exit ends of the plurality of internal cavities are aligned with the respective exit chutes, and wherein preformed members between all adjacent battery cell tabs of the battery array are simultaneously installed by plungers that push the preformed members through the exit chutes.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates a perspective view of an array of a battery pack from the electrified vehicle of FIG. 2 according to an exemplary embodiment of the present disclosure.

FIG. 3 illustrates a schematic view of a battery array and a thermal barrier insertion apparatus according to an exemplary embodiment of the present disclosure.

FIG. 4 illustrates a schematic side view of a thermal barrier insertion apparatus comprising a compression tube that is positioned between two battery cell tabs of the battery array according to an exemplary embodiment of the present disclosure.

FIG. 5 is a view similar to FIG. 4 but showing a plunger pushing a thermal barrier member into the compression tube.

FIG. 6 is a view similar to FIG. 5 but showing the plunger holding the thermal barrier member in place while the compression tube is extracted.

FIG. 7 illustrates a schematic side view of a thermal barrier insertion apparatus comprising a rotating drum that is used to insert a thermal barrier member between two battery cell tabs of the battery array according to an exemplary embodiment of the present disclosure.

FIG. 8 is a view similar to FIG. 7 but showing an internal cavity of the rotating drum aligned with an exit chute.

FIG. 9 is a view similar to FIG. 8 but showing a plunger pushing the thermal barrier member through the exit chute.

### DETAILED DESCRIPTION

This disclosure details a method and apparatus for providing a preformed thermal barrier member between adjacent cell tabs of a traction battery pack

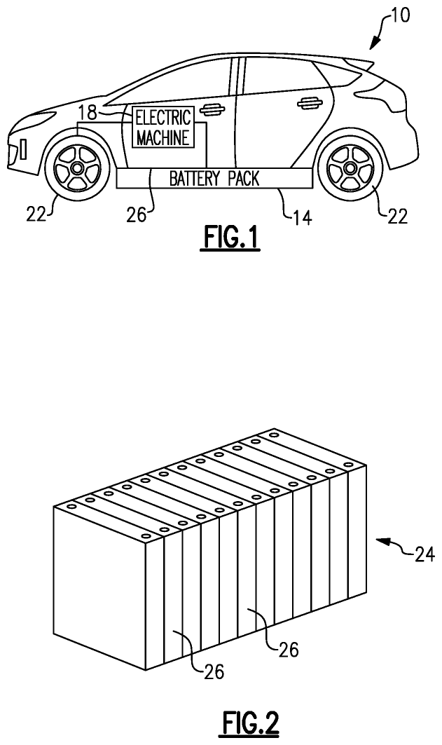

With reference to FIG. 1, an electrified vehicle 10 includes a traction battery pack assembly 14, an electric machine 18, and wheels 22. The traction battery pack assembly 14 powers an electric machine 18, which can convert electrical power to mechanical power to drive the wheels 22. The traction battery pack assembly 14 can be a relatively high-voltage battery.

The traction battery pack assembly 14 is, in the exemplary embodiment, secured to an underbody 26 of the electrified vehicle 10. The traction battery pack assembly 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

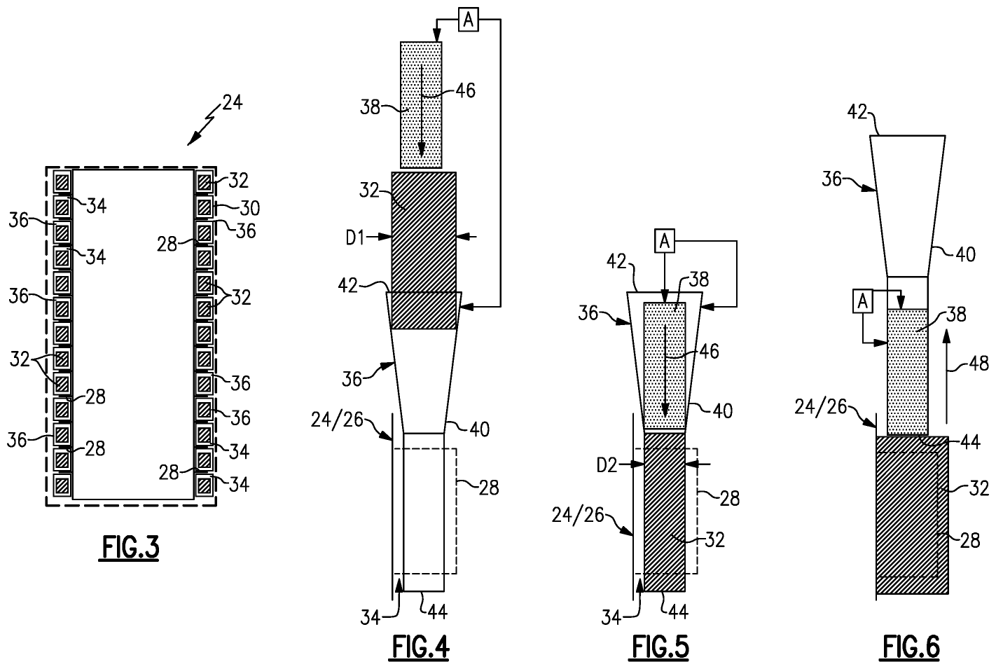

With reference now to FIGS. 2-3 the traction battery pack assembly 14 includes one or more battery arrays 24 that are configured to be housed within an enclosure (not shown). The battery arrays 24 each include a plurality of individual battery cells 26 as shown in FIG. 2. Any number of battery cells 26 could be used in the arrays 24. Additionally, any number of battery arrays 24 could be used in the vehicle 10.

In an embodiment, the battery cells 26 are prismatic, lithium-ion cells. However, battery cells having other geometries (cylindrical, pouch, etc.) and/or chemistries (nickel-metal hydride, lead-acid, etc.) could alternatively be utilized within the scope of this disclosure.

The battery cells 26 include tabs 28 as shown in FIG. 3. An insertion structure 30 is used to insert thermal barrier preformed members 32 into open spaces 34 located between adjacent cell tabs 28. The preformed members 32 are comprised of a thermal barrier material. In one example, the preformed members 32 are comprised of a flame retardant compressible foam material. One example of such a material is HB Fuller EV Protect; however, other similar materials could also be used.

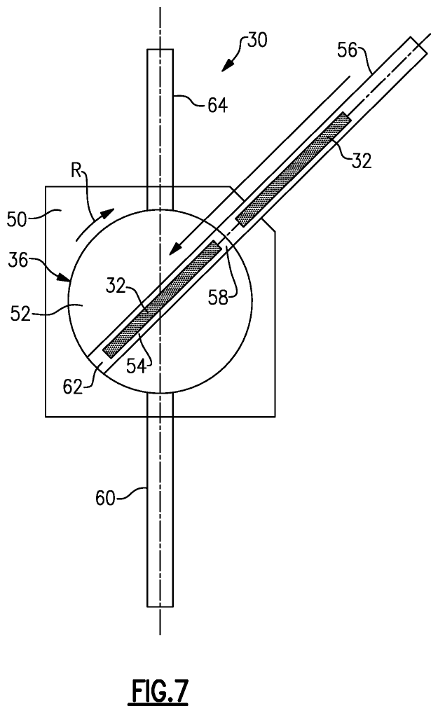

In one example, the insertion structure 30 comprises a tab thermal barrier insertion apparatus (TTBIA) that comprises a frame-like structure having at least one loader 36 configured to receive an associated preformed member 32. In one example, a plunger 38 (FIG. 4) pushes the preformed member 32 through the loader 36 and into the open area 34 between adjacent battery cell tabs 28 (FIG. 5) such that the preformed member expands to fill the open area 34 as shown in FIG. 6.

In one example, the preformed member 32 is compressed during insertion through the loader 36. This compression allows the preformed member 32 to be reduced in size to easily fit within the open area 34 with subsequent expansion after the insertion structure 30 is removed such that the member 32 completely and entirely fills the open area 34.

In one example, the at least one loader 36 comprises a plurality of loaders 36 such as that shown in FIG. 3. The frame-like structure of the insertion structure 30 is configured to hold the loaders 36 such that each loader 35 can be aligned with an open area 34 between adjacent battery cell tabs 28 as shown in FIG. 3. Once the insertion structure 30 is in the desired alignment configuration, the preformed members 32 are simultaneously pushed through the plurality of loaders 36 and into the open areas 34 such that all open areas 34 are filled at the same time. The insertion structure 30 is then extracted such that another set of preformed members 32 can be installed into another battery array 24.

In one example, the insertion structure 30 is comprised of a non-conductive material. This type of material is needed as the cell tabs 28 may be live during insertion of the thermal barrier material. One example, of a non-conductive material that can be used is plastic; however, other types of non-conductive materials could also be used.

In the example shown in FIGS. 4-6, the loaders 36 comprise a compression tube 40 having an intake end 42 and an exit end 44. In one example, the intake end 42 has a greater open cross-sectional area than an open cross-sectional area at the exit end 44 such that as the preformed member 32 is pushed through the compression tube 40, the preformed member 32 is compressed from an initial outer dimension D1 to a compressed outer dimension D2 that is less than the initial outer dimension D1. In one example, the intake end 42 comprise a tapered section with a gradually decreasing outer dimension that stops at a generally central or middle area of the compression tube 40. In one example, the exit end 44 comprises a section having a constant outer dimension that extends from the narrowest part of the tapered section to an exit opening.

As shown in FIG. 4, the compression tube 40 is first positioned in the open area 34 between the cell tabs 28. Next, as shown in FIG. 5, the plunger 38 pushes the preformed member 32 through the compression tube 40 along a linear path in a first direction (see arrow 46). The plunger 38 pushes the preformed member 32 into the exit end portion 44 while the compression tube 40 remains in place between the cell tabs 28 as shown in FIG. 5. Next, the plunger 38 continues to hold/push the preformed member 32 between the adjacent battery cell tabs 28 as the compression tube 40 is withdrawn/extracted from the open area 34 along a linear path in a second direction (see arrow 48), opposite of the first direction 46, as shown in FIG. 6. As the compression tube 40 is extracted, the preformed member 32 expands to completely fill in the open area 34.

In one example, a plurality of compression tubes 40 are supported by the frame-like structure of the insertion structure 30 as shown in FIG. 3. Each tube 40 is aligned with a respective open area 34 between adjacent battery cell tabs 28, and the preformed members 32 are simultaneously pushed through the tubes 40 by plungers 38. This provides for a quick and efficient method of installing all of the thermal barrier members at the same time.

In one example, the plungers 38 are moved by actuators A that are controlled via a control system (not shown). Movement of the insertion structure 30 and compression tubes 40 can also be controlled via actuators A and the control system. Any type of actuator capable of moving the associated components along the described paths of movement could be used.

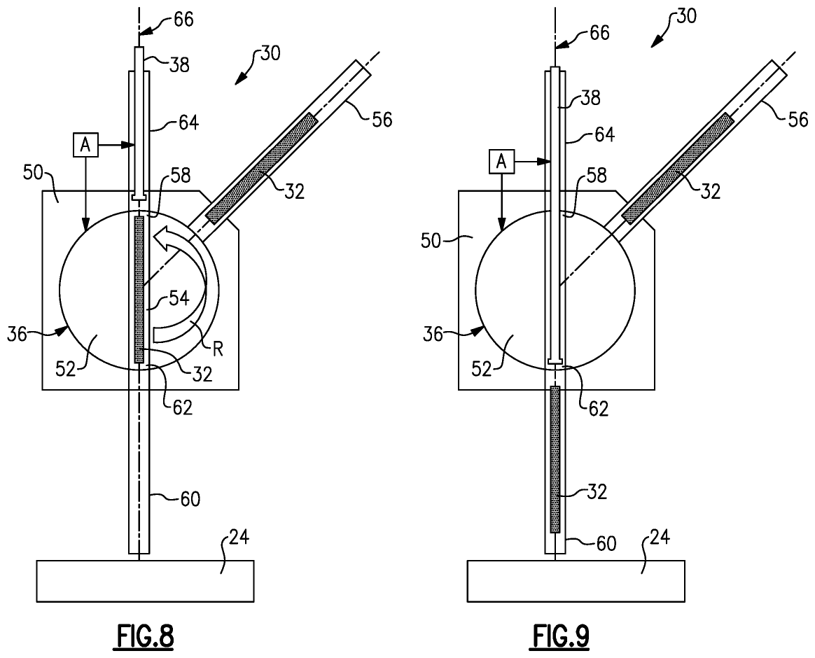

FIGS. 7-9 show another example of an insertion structure 30 with one or more loaders 36. In one example, the loader 36 comprises a drum 52 that is rotatably supported with a housing 50 by bearings or other similar structures (not shown). The drum 52 includes at least one internal cavity 54 sized to receive one preformed member 32. In one example, the insertion structure 30 further includes an intake chute 56 to be aligned with an intake end 58 of the internal cavity 54, and an exit chute 60 to be aligned with an exit end 62 of the internal cavity 54. In one example, the plunger 38 is received within a pusher chute 64.

The drum 52 is first rotated (see arrow R) within the fixed housing 50 such that the exit end 62 is blocked by the housing 50 and the intake end 58 is aligned with the intake chute 56 as shown in FIG. 7. The preformed member 32 is then loaded into the internal cavity 54. The internal cavity 54 is sized such that only one preformed member 32 can be inserted into the cavity 54 at a time. The drum 52 is subsequently rotated relative to the fixed housing 50 such that the intake chute 56 is blocked by the drum 52, the intake end 58 is aligned with the pusher chute 64, and the exit end 62 is aligned with the exit chute 60 as shown in FIG. 8. The plunger 38 then pushes the preformed member 32 along a linear path 66 through the exit chute 60 and into the open area 34 between the adjacent battery cell tabs 28. In one example, the preformed member 32 is compressed within the exit chute 60 such that when the insertion structure 30 is extracted, the preformed member 32 can expand to completely fill the open area 34. In one example, the exit chute 60 can be configured with a tapering section similar to that used in the example of FIGS. 3-6 to compress the preformed member 32.

In one example, the drum 52 is rotated about an axis that is perpendicular to the linear path 66.

In one example, the drum 52 is configured to include a plurality of internal cavities 54 such that all of the open areas 34 of the array 24 can be filled simultaneously. In one example, the frame-like structure of the insertion structure 30 shown in FIG. 3 can be configured to support one housing 50 and drum 52 for one side of the array 24 and another housing 50 and drum 52 for the other side of the array. In this example, each internal cavity 54 is first aligned with the intake chute 56 and then the preformed members 32 are loaded into the respective internal cavities 54. Then the drums 52 are rotated such that each internal cavity 54 is aligned with a respective open area 34 between adjacent battery cell tabs 28 with the exit ends 62 of the internal cavities 54 being aligned with respective exit chutes 60. The preformed members 32 between all adjacent battery cell tabs 28 of the battery array 24 are then simultaneously installed by plungers 38 that push and compress the preformed members 32 through the exit chutes 60.

As discussed above, the plungers 38 are moved by actuators A that are controlled via a control system. Movement of the insertion structure 30 and drums 52/housings 50 can also be controlled via actuators A and the control system. Any type of actuator capable of moving the associated components along the described paths of movement could be used.

The subject disclosure implements a thermal barrier solution (TBS) between the cell tabs 28 during array assembly. The subject TBS comprises preformed members 32 that are made from a compressible foam material. This provides benefits over other solutions such as using liquid that expands. TBS in liquid form can have issues in application and also requires additional time to form/cure. The use of preformed TBS (pTBS) material that is sized to fit between the tabs 28 is much easier to implement during the assembly process without the need for additional time to form/cure.

The subject disclosure further provides a nonconductive insertion apparatus comprising a TTBIA 30. The TTBIA 30 is inserted into the array tab area of the array 24 and the preformed members 32 are inserted into the top of the loaders 36. The plungers 38 push the members 32 down through the loaders 36. Once the members 32 are loaded into the compression tubes 40 or exit chutes 60, the plungers 38 continues to hold/push the members 32 while the TTBIA 30 is extracted from the array tab area. The members 32 thus remain in the area 34 between the tabs 28 and the members 32 expand to their maximum dimensions filling the open area 34.

Using a plurality of loaders 36 is a significant time saver as compared to manually inserting the members 32. By using the TTBIA 30, over-sized members 32 can be used that are subsequently compressed such that when they expand, they fill all of the gaps to provide better thermal protection by eliminating gaps between cell tabs 28. Using the TTBIA 30 also provides the ability to create an automated insertion process that significantly speeds up the assembly of the array 24.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A method, comprising:
providing an insertion apparatus having at least one loader;
inserting a preformed member comprised of a thermal barrier material into the at least one loader;
pushing the preformed member through the at least one loader and into an open area between adjacent battery cell tabs such that the preformed member expands to fill the open area.

2. The method according to claim 1, wherein the thermal barrier material comprises a compressible foam material, and including compressing the preformed member during insertion through the at least one loader.

3. The method according to claim 1, wherein the at least one loader comprises a plurality of loaders, and including:
providing a battery array comprised of a plurality of battery cells that each have battery cell tabs;
aligning the plurality of loaders with respective open areas between adjacent battery cell tabs; and
simultaneously pushing preformed members through the plurality of loaders and into the open areas such that all open areas are filled at the same time.

4. The method according to claim 1, wherein the insertion apparatus is comprised of a non-conductive material.

5. The method according to claim 1, wherein the at least one loader comprises a compression tube having an intake end and an exit end, and including forming the intake end to have a greater open cross-sectional area than an open cross-sectional area at the exit end such that as the preformed member is pushed through the compression tube, the preformed member is compressed from an initial outer dimension to a compressed outer dimension that is less than the initial outer dimension.

6. The method according to claim 5, including using a plunger to push the preformed member through the compression tube.

7. The method according to claim 6, including positioning the exit end of the compression tube between the adjacent battery cell tabs and pushing the preformed member toward the exit end and using the plunger to hold the preformed member between the adjacent battery cell tabs as the compression tube is withdrawn from the open area.

8. The method according to claim 7, including providing a plurality of compression tubes each aligned with a respective open area between adjacent battery cell tabs of a battery array comprised of a plurality of battery cells, and simultaneously installing preformed members between all adjacent battery cell tabs of the battery array.

9. The method according to claim 1, wherein the at least one loader comprises a housing and a drum received within the housing, wherein the drum includes at least one internal cavity sized to receive one preformed member, and including an intake chute to be aligned with an intake end of the at least one internal cavity, and an exit chute to be aligned with an exit end of the at least one internal cavity, and including:
rotating the drum within the housing such that the exit end is blocked and the intake end is aligned with the intake chute;
loading the preformed member into the at least one internal cavity;
rotating the drum within the housing such that the exit end is aligned with the exit chute and the intake chute is blocked; and
pushing the preformed member through the exit chute and into the open area between the adjacent battery cell tabs.

10. The method according to claim 9, wherein the at least one internal cavity comprises a plurality of internal cavities formed within the drum, and including aligning each internal cavity with a respective open area between adjacent battery cell tabs of a battery array comprised of a plurality of battery cells such that the exit ends of the plurality of internal cavities are aligned with the respective exit chutes, and simultaneously installing preformed members between all adjacent battery cell tabs of the battery array by pushing the preformed members through the exit chutes.

11. An apparatus comprising:
a preformed member comprised of a thermal barrier material;
an insertion structure having at least one loader configured to receive the preformed member; and
a plunger that pushes the preformed member through the at least one loader and into an open area between adjacent battery cell tabs such that the preformed member expands to fill the open area.

12. The apparatus according to claim 11, wherein the preformed member is comprised of a compressible foam material that is compressed during insertion through the at least one loader.

13. The apparatus according to claim 11, wherein the at least one loader comprises a plurality of loaders, and including a battery array comprised of a plurality of battery cells that each have battery cell tabs, and wherein the plurality of loaders are aligned with respective open areas between adjacent battery cell tabs, and wherein preformed members are simultaneously pushed through the plurality of loaders and into the open areas such that all open areas are filled at the same time.

14. The apparatus according to claim 11, wherein the insertion structure is comprised of a non-conductive material.

15. The apparatus according to claim 11, wherein the at least one loader comprises a compression tube having an intake end and an exit end, and wherein the intake end has a greater open cross-sectional area than an open cross-sectional area at the exit end such that as the preformed member is pushed through the compression tube, the preformed member is compressed from an initial outer dimension to a compressed outer dimension that is less than the initial outer dimension.

16. The apparatus according to claim 15, wherein the plunger pushes the preformed member through the compression tube.

17. The apparatus according to claim 16, wherein the exit end of the compression tube is positioned between the adjacent battery cell tabs and the preformed member is pushed toward the exit end and the plunger holds the preformed member between the adjacent battery cell tabs as the compression tube is withdrawn from the open area.

18. The apparatus according to claim 17, wherein the compression tube comprises a plurality of compression tubes that are each aligned with a respective open area between adjacent battery cell tabs of a battery array comprised of a plurality of battery cells, and wherein preformed members are simultaneously installed between all adjacent battery cell tabs of the battery array.

19. The apparatus according to claim 11, wherein the at least one loader comprises a housing and a drum received within the housing, wherein the drum includes at least one internal cavity sized to receive one preformed member, and including an intake chute to be aligned with an intake end of the at least one internal cavity, and an exit chute to be aligned with an exit end of the at least one internal cavity, and wherein:
the drum is first rotated within the housing such that the exit end is blocked and the intake end is aligned with the intake chute such that the preformed member is loaded into the at least one internal cavity;
the drum is subsequently rotated within the housing such that the exit end is aligned with the exit chute and the intake chute is blocked; and
the plunger pushes the preformed member through the exit chute and into the open area between the adjacent battery cell tabs.

20. The apparatus according to claim 19, wherein the at least one internal cavity comprises a plurality of internal cavities formed within the drum, where each internal cavity is aligned with a respective open area between adjacent battery cell tabs of a battery array comprised of a plurality of battery cells such that the exit ends of the plurality of internal cavities are aligned with the respective exit chutes, and wherein preformed members between all adjacent battery cell tabs of the battery array are simultaneously installed by plungers that push the preformed members through the exit chutes.
